(19) United States
(12) Patent Application Publication
(10) Pub. No.: US 2010/0239836 A1
(43) Pub. Date: Sep. 23, 2010

(54) IMPACT-ABSORBING MATERIAL

(75) Inventors: Kazumichi KATO, Osaka (JP); Makoto SAITOU, Osaka (JP); Hiroki FUJII, Osaka (JP); Itsuhiro HATANAKA, Osaka (JP)

Correspondence Address: SUGHRUE-265550, 2100 PENNSYLVANIA AVE. NW, WASHINGTON, DC, 20037-3213, US

(73) Assignee: NITTO DENKO CORPORATION, Osaka (JP)

(21) Appl. No.: 12/725,691

(22) Filed: Mar. 17, 2010

(30) Foreign Application Priority Data
Mar. 17, 2009 (JP) 2009-065004

(51) Int. Cl. B32B 5/00; B32B 3/26; C09J 7/02

(52) U.S. Cl. 428/220; 428/317.3

(57) ABSTRACT

The present invention relates to an impact-absorbing material including a foam having a thickness of from 0.1 to 1.0 mm, an average cell size of from 10 to 65 μm and a density of from 0.01 to 0.20 g/cm³ and having an impact-absorbing property, as defined in the following expression (1), of from 40 to 90%: Impact-absorbing property (%)=(F0−F1)/F0×100 (1), in which F0 represents an impact force at the time of making an impactor collide with only a support plate; and F1 represents an impact force at the time of making an impactor collide with a support plate of a structure composed of the support plate and the impact-absorbing material.

The present invention relates to an impact-absorbing material showing an excellent impact-absorbing property.

### FIELD OF THE INVENTION

Conventionally, in fixing an image display member fixed to an image display device such as a liquid crystal display, an electroluminescence display and a plasma display, or an optical member fixed to a so-called “cellular phone” or “personal digital assistant” or the like, such as a camera and a lens, to a prescribed site (a fixing part, etc.), a foamed material is used. As such a foamed material, in addition to fine cell urethane-based foams with low expansion and having a closed-cell structure and materials obtained by compression molding a high-expansion urethane, polyethylene-based foams having closed cells and having an expansion ratio of about 30 times have been used. Specifically, for example, a gasket composed of a polyurethane-based foam having a density of from 0.3 to 0.5 g/cm³ (see JP-A-2001-100216), a sealing material for electric and electronic equipments composed of a foam structure having an average cell size of from 1 to 500 μm (see JP-A-2002-309198) and the like are used.

Also, conventionally, in an image display member installed in an image display device such as a liquid crystal display, an electroluminescence display and a plasma display, or an optical member installed in a so-called “cellular phone” or “personal digital assistant” or the like, such as a camera and a lens, a clearance of a portion where a foamed material is used is sufficiently large, and therefore, it was possible to use the foamed material even without being overly compressed. In consequence, it was not necessary to especially worry about a compression repulsive force which the foamed material has.

However, in recent years, as the thickness of a product in which an optical member (for example, an image display device, a camera, a lens, etc.) is installed (set) becomes thin, the clearance of a portion where a foamed material is used tends to decrease. Also, recently, the situation where a conventionally used foamed material cannot be used because of a high repulsive force thereof is occurring. For example, in the case where the conventional foamed material is used for such a thin-type optical member, there was the case where the optical member is broken even by a small impact.

Also, following a decrease of the clearance, it is necessary to make the thickness of the foamed material thin. However, when the thickness of the foam is made thin, a cushioning property is lowered. Therefore, a foamed material showing an excellent impact-absorbing property even when the thickness is thin is demanded.

Furthermore, unlike a liquid crystal module, an electroluminescence (EL) module is required to achieve thinning of a panel itself and also to use a cushioning material which is thin and excellent in an impact-absorbing property because it is not provided with a backlight unit.

For example, in the foregoing gasket (namely, the gasket composed of a polyurethane-based foam having a density of from 0.3 to 0.5 g/cm³ (see JP-A-2001-100216)), although it is described that backlash of a liquid crystal display screen is prevented by suppressing an expansion ratio, flexibility and cushioning property thereof are not sufficient.

Also, in the foregoing sealing material for electric and electronic equipments (namely, the sealing material for electric and electronic equipments composed of a foam structure having an average cell size of from 1 to 500 μm (see JP-A-2002-309198)), although the compression repulsive force as a foamed material is not mentioned, since the average cell size is large, when the sealing material is made thin, a pinhole is generated, whereby it does not function as a gasket.

Furthermore, there is disclosed a foamed dust-proof material having an excellent dust-proof property and also excellent flexibility such that it is able to follow even a fine clearance (see JP-A-2005-97566). However, a thickness thereof is not mentioned. In conventional foamed materials, in the case of making the thickness thin, it was difficult to obtain a sufficiently satisfactory impact-absorbing property.

### SUMMARY OF THE INVENTION

For those reasons, a foamed material which is able to exhibit an excellent impact-absorbing property and which, even when the thickness is thin, has excellent flexibility such that it is able to follow a fine clearance is demanded.

Accordingly, an object of the invention is to provide an impact-absorbing material which, even when the thickness is thin, has excellent flexibility and an excellent impact-absorbing property and which is able to follow even a fine clearance.

In order to solve the foregoing problems, the present inventors made extensive and intensive investigations. As a result, it has been found that, by constructing an impact-absorbing material to include a foam having a thickness of from 0.1 to 1.0 mm, an average cell size of from 10 to 65 μm and a density of from 0.01 to 0.20 g/cm³ and by controlling the impact-absorbing property thereof within a specified range, even when the thickness thereof is thin, the impact-absorbing material is able to show excellent flexibility and an excellent impact-absorbing property and further to well follow a fine clearance, thereby leading to accomplishment of the invention.

Namely, the present invention relates to the following items 1. to 13.

1. An impact-absorbing material including a foam having a thickness of from 0.1 to 1.0 mm, an average cell size of from 10 to 65 μm and a density of from 0.01 to 0.20 g/cm³ and having an impact-absorbing property, as defined in the following expression (1), of from 40 to 90%:

Impact-absorbing property(%)=(F0−F1)/F0×100 (1)

in which F0 represents an impact force at the time of making an impactor collide with only a support plate; and F1 represents an impact force at the time of making an impactor collide with a support plate of a structure composed of the support plate and the impact-absorbing material.

2. The impact-absorbing material according to item 1, having an impact-absorbing characteristic such that, in a falling ball test in which a laminate obtained by laminating a polarizing plate, an LCD panel, a double-coated pressure-sensitive adhesive tape, the impact-absorbing material and a double-coated pressure-sensitive adhesive tape in this order, with the polarizing plate being an upper surface, is used as a module, and after locating an acrylic plate on the upper surface of the module, an operation of freely falling a 0.39 N-steel ball on the acrylic plate from a height of 150 cm is repeated until the LCD panel is broken, the number of repetition measured at the time when the breakage is first generated on the LCD panel is 80 times or more.

3. The impact-absorbing material according to item 1 or 2, having a load against repulsion upon compression to 0.1 mm-thickness of from 0.005 to 0.100 MPa.

4. The impact-absorbing material according to any one of items 1 to 3, having a tensile strength of from 3.0 to 11.0 MPa.

5. The impact-absorbing material according to any one of items 1 to 4, in which the foam is formed through steps of impregnating a resin composition with a high-pressure inert gas and then reducing the pressure.

6. The impact-absorbing material according to any one of items 1 to 4, in which the foam is formed through steps of impregnating an unfoamed molded article including a resin composition with a high-pressure inert gas and then reducing the pressure.

7. The impact-absorbing material according to any one of items 1 to 4, in which the foam is formed through steps of impregnating a molten resin composition with an inert gas under pressure and then reducing the pressure and simultaneously molding.

8. The impact-absorbing material according to any one of items 5 to 7, in which heating is carried out after the pressure reduction or simultaneously with the pressure reduction.

9. The impact-absorbing material according to any one of items 5 to 8, in which the inert gas is carbon dioxide.

10. The impact-absorbing material according to any one of items 5 to 9, in which the inert gas is in a supercritical state.

11. The impact-absorbing material according to any one of items 1 to 10, in which a pressure-sensitive adhesive layer is provided on one surface or both surfaces of the foam.

12. The impact-absorbing material according to item 11, in which the pressure-sensitive adhesive layer is formed on the foam through a film layer.

13. The impact-absorbing material according to item 11 or 12, in which the pressure-sensitive adhesive layer is formed of an acrylic pressure-sensitive adhesive.

According to the impact-absorbing material of the invention, since it has the foregoing constitution, even when the thickness is thin, it is able to have excellent flexibility and an excellent impact-absorbing property and to follow a fine clearance.

### BRIEF DESCRIPTION OF THE DRAWINGS

FIG. 1 is a diagrammatic constitutional view of an impact tester.

FIG. 2 is a view showing a diagrammatic constitution of a holding member of an impact tester.

FIG. 3 is a schematic view of a module of a falling ball test.

### DESCRIPTION OF REFERENCE NUMERALS AND SIGNS

1: Impact tester (pendulum type device)
2: Specimen (impact-absorbing material)
3: Holding member
4: Impact-loading member
5: Pressure sensor
11: Fixing jig
12: Pressing jig
16: Pressure regulator
20: Support
21: Arm
22: One end of support bar (shaft)
23: Support bar (shaft)
24: Impactor
25: Electromagnet
28: Support plate
a: Swing angle
101: Polarizing plate
102: LCD panel
103: Double-coated pressure-sensitive adhesive tape
104: Impact-absorbing material
105: Double-coated pressure-sensitive adhesive tape

### DETAILED DESCRIPTION OF THE INVENTION

The impact-absorbing material of the invention includes a foam having a thickness of from 0.1 to 1.0 mm, an average cell size of from 10 to 65 μm and a density of from 0.01 to 0.20 g/cm³ and has an impact-absorbing property, as defined in the following expression (1), of from 40 to 90%.

Impact-absorbing property(%)=(F0−F1)/F0×100 (1)

In the expression (1), F0 represents an impact force at the time of making an impactor collide with only a support plate; and F1 represents an impact force at the time of making an impactor collide with a support plate of a structure composed of the support plate and the impact-absorbing material.

Foam

The foam which is included in the impact-absorbing material of the invention has a thickness of from 0.1 to 1.0 mm, an average cell size of from 10 to 65 μm and a density of from 0.01 to 0.20 g/cm³. In general, the foam is prepared by foaming and molding a resin composition. In view of the fact that the impact-absorbing material of the invention includes such a foam, it has a desired impact-absorbing property.

The thickness of the foam is from 0.1 to 1.0 mm, and preferably from 0.15 to 0.5 mm. When the thickness of the foam is less than 0.1 mm, there may be the case where the dust-proof property is lowered. On the other hand, when the thickness of the foam exceeds 1.0 mm, there may be the case where when a load against repulsion upon compression to 0.1 mm-thickness becomes high, or the case where the impact-absorbing material is not able to follow a fine clearance (for example, a clearance of from 0.10 to 0.30 mm).

The average cell size of the foam is from 10 to 65 μm. By regulating an upper limit of the average cell size of the foam to 65 μm or less (preferably 60 μm or less, and more preferably 55 μm or less), not only the dust-proof property can be enhanced, but a light-shielding property can be made favorable. On the other hand, by regulating a lower limit of the average cell size of the foam to 10 μm or more (preferably 15 μm or more, and more preferably 20 μm or more), a cushioning property (impact-absorbing property) can be made favorable.

The density of the foam is from 0.01 to 0.20 g/cm³. By regulating an upper limit of the density of the foam to 0.20 g/cm³ or less (preferably 0.15 g/cm³ or less, and more preferably 0.12 g/cm³ or less), flexibility can be enhanced. On the other hand, by regulating a lower limit of the density of the foam to 0.01 g/cm³ or more (preferably 0.02 g/cm³ or more), an excellent dust-proof property can be secured.

Such a foam is not particularly limited with respect to its composition and cell structure and the like so far as it has the foregoing characteristics. For example, a closed-cell structure or a semi-interconnected and semi-closed-cell structure (a cell structure where a closed-cell structure and an interconnected-cell structure are mixed, and a proportion thereof is not particularly limited) is preferable. In particular, a cell structure in which the closed-cell structure accounts for 80% or more (particularly 90% or more) in the foam is especially suitable.

The foam has a thin thickness, has a fine cell structure, has both flexibility and an impact-absorbing property and has high expansion and lightweight. Furthermore, the foam is excellent in the dust-proof property. Moreover, since the foam has a fine cell structure, it also has shape processability. For that reason, the foam is able to suitably constitute an impact-absorbing material.

In particular, even when the foam is formed in a thickness of from 0.10 to 0.30 mm, it has an excellent impact-absorbing property.

In view of the fact that the foam has the foregoing characteristics, even when a thickness thereof is thin, it is able to show favorable followability even against a fine clearance (for example, a clearance of from 0.10 to 0.30 mm).

Also, in the case where the thickness of the foam exceeds 0.1 mm, a load against repulsion upon compression to 0.1 mm-thickness (a repulsive stress upon compression to 0.1 mm-thickness) is preferably from 0.005 to 0.100 MPa, more preferably from 0.008 to 0.070 MPa, and further preferably from 0.010 to 0.040 MPa. In order to obtain a suitable repulsive stress upon compression to 0.1 mm-thickness as the whole of the impact-absorbing material when used for an impact-absorbing material, and to obtain favorable clearance followability, impact-absorbing property and dust-proof property, the foam preferably has the above-mentioned load against repulsion.

Furthermore, from the standpoints that when used for an impact-absorbing material, a suitable tensile strength as the whole of the impact-absorbing material is obtainable; and that when set or processed, the foam has workability such that destruction of the foam is not caused, a tensile strength of the foam is preferably from 3.0 to 11.0 MPa, more preferably from 3.5 to 10.5 MPa, and further preferably from 3.8 to 10.0 MPa.

Resin Composition

The resin composition is a composition for forming the foam and contains at least a thermoplastic polymer which is a material of the foam (resin foam). Such a thermoplastic polymer is a polymer showing thermoplasticity and is not particularly limited so far as it is able to impregnate a high-pressure gas therein. Examples of such a thermoplastic polymer include olefin-based polymers such as low density polyethylene, medium density polyethylene, high density polyethylene, linear low density polyethylene, polypropylene, a copolymer of ethylene and propylene, a copolymer of ethylene or propylene and other α-olefin and a copolymer of ethylene and other ethylenically unsaturated monomer (for example, vinyl acetate, acrylic acid, acrylic esters, methacrylic acid, methacrylic esters, vinyl alcohol, etc.); styrene-based polymers such as polystyrene and an acrylonitrile-butadiene-styrene copolymer (ABS resin); polyamides such as 6-nylon, 66-nylon and 12-nylon; polyamide-imides; polyurethanes; polyimides; polyether imides; acrylic resins such as polymethyl methacrylate; polyvinyl chloride; polyvinyl fluoride; alkenyl aromatic resins; polyesters such as polyethylene terephthalate and polybutylene terephthalate; polycarbonates such as bisphenol A based polycarbonate; polyacetals; and polyphenylene sulfides.

Also, the foregoing thermoplastic polymer includes a thermoplastic elastomer which shows properties as a rubber at normal temperature and which shows thermoplasticity at a high temperature. Examples of such a thermoplastic elastomer include olefin-based elastomers such as an ethylene-propylene copolymer, an ethylene-propylene-diene copolymer, an ethylene-vinyl acetate copolymer, polybutene, polyisobutylene and chlorinated polyethylene; styrene-based elastomers such as a styrene-butadiene-styrene copolymer, a styrene-isoprene-styrene copolymer, a styrene-isoprene-butadiene-styrene copolymer and hydrogenated polymers thereof; thermoplastic polyester-based elastomers; thermoplastic polyurethane-based elastomers; and thermoplastic acrylic elastomers. In such a thermoplastic elastomer, for example, since a glass transition temperature thereof is not higher than room temperature (for example, not higher than 20° C.), when applied to an impact-absorbing material, it is remarkably excellent in flexibility and shape followability.

The thermoplastic polymer can be used alone or in admixture of two or more kinds thereof. Also, as the material (thermoplastic polymer) of the foam, any of a thermoplastic elastomer, a thermoplastic polymer other than a thermoplastic elastomer and a mixture of a thermoplastic elastomer and a thermoplastic polymer other than a thermoplastic elastomer can be used.

Examples of the mixture of a thermoplastic elastomer and a thermoplastic polymer other than a thermoplastic elastomer include mixtures of an olefin-based elastomer (for example, an ethylene-propylene copolymer, etc.) and an olefin-based polymer (for example, polypropylene, etc.). In the case of using a mixture of a thermoplastic elastomer and a thermoplastic polymer other than a thermoplastic elastomer, a mixing ratio thereof is, for example, from about 1/99 to 99/1 (preferably from about 10/90 to 90/10, and more preferably from about 20/80 to 80/20) in terms of a ratio of the former to the latter.

An additive may be added to the resin composition according to the necessity. The type of the additive is not particularly limited, and a variety of additives which are usually used in foaming and molding can be used. Examples of such an additive include a cell nucleator, a crystal nucleator, a plasticizer, a lubricant, a coloring agent (for example, a pigment, a dye, etc.), an ultraviolet absorbent, an antioxidant, an aging inhibitor, a filler, a reinforcing agent, a flame retardant, an antistatic agent, a surfactant, a vulcanizing agent, a surface-treating agent and an anti-shrinking agent. An addition amount of the additive can be properly chosen within the range where the cell formation or the like is not impaired; and addition amounts which are usually used in foaming and molding of a foam made of, as a material, a thermoplastic polymer such as a thermoplastic elastomer can be adopted. The additive can be used alone or in combinations of two or more kinds thereof.

The lubricant has actions to enhance fluidity of the thermoplastic polymer and also to suppress heat deterioration of the polymer. The lubricant to be used in the invention is not particularly limited so far as it shows an effect for enhancing fluidity of the thermoplastic polymer. Examples thereof include hydrocarbon based-lubricants such as liquid paraffin, paraffin wax, micro wax and polyethylene wax; aliphatic acid-based lubricants such as stearic acid, behenic acid and 12-hydroxystearic acid; and ester based-lubricants such as butyl stearate, stearic acid monoglyceride, pentaerythritol tetrastearate, hydrogenated castor oil and stearyl stearate. Such a lubricant can be used alone or in combinations of two or more kinds thereof.

An addition amount of the lubricant is, for example, from 0.5 to 10 parts by weight (preferably from 0.8 to 8 parts by weight, and more preferably from 1 to 6 parts by weight) based on 100 parts by weight of the thermoplastic polymer. When the addition amount of the lubricant exceeds 10 parts by weight, there is a concern that fluidity is excessively high, thereby causing a lowering of the expansion ratio. On the other hand, when the addition amount of the lubricant is less than 0.5 parts by weight, there is a concern that it is unable to contrive to enhance fluidity, and stretchability at the time of foaming is lowered, thereby causing a lowering of the expansion ratio.

Also, the anti-shrinking agent has an action to form a molecular film on the surface of a cell film of the foam, thereby effectively suppressing permeation of a foaming agent gas. The anti-shrinking agent to be used in the invention is not particularly limited so far as it shows an effect for suppressing permeation of a foaming agent gas. Examples thereof include aliphatic acid metal salts (for example, salts of aluminum, calcium, magnesium, lithium, barium, zinc or lead of a aliphatic acid such as stearic acid, behenic acid and 12-hydroxystearic acid, etc.); and aliphatic acid amides (aliphatic acid amides of a aliphatic acid having from about 12 to 38 carbon atoms (preferably from about 12 to 22 carbon atoms) (although the amide may be any of a monoamide or a bisamide, the bisamide is suitably used for the purpose of obtaining a fine cell structure); for example, stearic acid amide, oleic acid amide, erucic acid amide, methylene bisstearic acid amide, ethylene bisstearic acid amide, lauric acid bisamide, etc.). Such an anti-shrinking agent can be used alone or in combinations of two or more kinds thereof.

An addition amount of the anti-shrinking agent is, for example, from 0.5 to 10 parts by weight (preferably from 0.7 to 8 parts by weight, and more preferably from 1 to 6 parts by weight) based on 100 parts by weight of the thermoplastic polymer. When the addition amount of the anti-shrinking agent exceeds 10 parts by weight, since gas efficiency is lowered in a cell expansion process, there is a concern that although a foam having a small cell size is obtained, an unfoamed portion increases, thereby causing a lowering of the expansion ratio. On the other hand, when the addition amount of the anti-shrinking agent is less than 0.5 parts by weight, there is a concern that the formation of a coating film is not sufficient, gas leakage is generated at the time of foaming, and shrinkage occurs, thereby causing a lowering of the expansion ratio.

Although the additive is not particularly limited, for example, a combination of the foregoing lubricant and the foregoing anti-shrinking agent may be used. For example, a combination of a lubricant such as stearic acid monoglyceride and an anti-shrinking agent such as erucic acid amide and lauric acid bisamide may be used.

It is preferable that the resin composition contains a cell nucleator. Examples of the cell nucleator include oxides, complex oxides, metal carbonates, metal sulfates and metal hydroxides, for example, talc, silica, alumina, mica, titania, zinc oxide, zeolite, calcium carbonate, magnesium carbonate, barium sulfate, aluminum hydroxide, magnesium hydroxide, etc. By incorporating such a cell nucleator into the resin composition, a foam capable of being easily regulated with respect to a cell size thereof and having adequate flexibility and an excellent impact-absorbing property can be easily obtained. The cell nucleator can be used alone or in combinations with two or more kinds thereof.

An addition amount of the cell nucleator is, for example, from 0.5 to 150 parts by weight, preferably from 2 to 140 parts by weight, and more preferably from 3 to 130 parts by weight based on 100 parts by weight of the thermoplastic polymer. When the amount of the cell nucleator to be used is too small, the effect of the cell nucleator is hardly obtainable, whereas when it is too large, the foaming tends to be impaired.

The resin composition is obtained by a known and/or customary method. For example, the resin composition is obtained by adding an additive to the resin serving as a raw material of the foam according to the necessity and kneading the mixture. In kneading, the mixture may be heated.

Examples of a specific embodiment of the resin composition which is used for the formation of the foam of the invention include a resin composition containing at least the foregoing mixture of a thermoplastic elastomer and a thermoplastic polymer other than a thermoplastic elastomer, the foregoing cell nucleator, the foregoing lubricant and the foregoing anti-shrinking agent, in which a content of the cell nucleator (in particular, a metal oxide) is from 0.5 to 150 parts by weight, a content of the lubricant (in particular, an ester-based lubricant) is from 0.5 to 10 parts by weight, and a content of the anti-shrinking agent (in particular, a aliphatic acid amide) is from 0.5 to 10 parts by weight based on 100 parts by weight of the mixture of a thermoplastic elastomer and a thermoplastic polymer other than a thermoplastic elastomer.

Production Method of Foam

In the foam which is included in the impact-absorbing material of the invention, a method which is usually used for the foaming and molding, such as a physical method and a chemical method, can be adopted as a method for producing the foam. The general physical method is a method of forming cells by dispersing a low-boiling liquid (foaming agent) such as a chlorofluorocarbon and a hydrocarbon in a polymer and subsequently heating the dispersion to volatilize the foaming agent. Also, the general chemical method is a method of obtaining a foam by forming cells by a gas generated by thermal decomposition of a compound (foaming agent) added to a base polymer. In view of a recent environmental issue and the like, the physical method is preferable.

In the production of such a foam, there can be adopted a method in which constituent components of the resin composition, such as a thermoplastic polymer and an additive, are kneaded by a kneading machine such as a Banbury mixer and a pressure kneader to obtain a resin composition (kneaded composition), which is then molded in a sheet form or a rod form while continuously kneading by calender, extruder, conveyor belt casting or the like, the molded article is heated for vulcanization and foaming, and the resulting vulcanized foam is cut into a prescribed shape according to the necessity; a method in which constituent components of the resin composition, such as a thermoplastic polymer and an additive, are kneaded by a mixing roller, and this resin composition (kneaded composition) is vulcanized, foamed and molded using a die in a batch system; and the like.

In particular, in the invention, in view of the fact that a foam having a small cell size and a high cell density is obtainable, a method of using a high-pressure inert gas as the foaming agent, for example, a method of forming a foam through the steps of impregnating a resin composition with a high-pressure inert gas and then reducing the pressure, is preferable. In particular, since a clean foam with less impurities can be obtained, carbon dioxide is preferably used as the foaming agent. According to the foregoing foaming method by a physical method, influences against the environment such as inflammability or toxicity and ozone depletion due to a substance which is used as the foaming agent are concerned. Also, according to the foaming method by a chemical method, since a residue of the foaming gas remains in the foam, in particular, in applications to electronic equipments in which requirements for low contamination are high, contamination due to a corrosive gas or impurities in the gas becomes a problem. In any of these physical foaming method and chemical foaming method, it is difficult to form a fine cell structure. In particular, it is said that it is extremely difficult to form fine cells of 300 μm or less.

In this way, in the invention, as a method for producing a foam, a production method utilizing a method using a high-pressure inert gas as the foaming agent is suitable. As described previously, a method of forming a foam through the steps of impregnating a resin composition with a high-pressure inert gas and then reducing the pressure can be suitably adopted. At the time of impregnation with an inert gas, an unfoamed molded article which has been molded in advance may be impregnated with an inert gas, or a molten resin composition is impregnated with an inert gas under pressure. In consequence, specifically, as a method for producing the foam, for example, a method of forming a foam through the steps of impregnating a resin composition with a high-pressure inert gas and then reducing the pressure; a method of forming a foam through the steps of impregnating an unfoamed molded article including a resin composition with a high-pressure inert gas and then reducing the pressure; a method of forming a foam through the steps of impregnating a molten resin composition with an inert gas under pressure and then reducing the pressure and simultaneously molding; and the like are suitable.

Specific examples of the method for producing a foam by impregnating a resin composition with a high-pressure inert gas include a method including a gas impregnation step of impregnating a resin composition with an inert gas under a high pressure; a pressure reduction step of, after the impregnation step, decreasing the pressure to perform foaming; and optionally, a heating step of expanding cells upon beating. In that case, as described previously, an unfoamed molded article which has been molded from a resin composition in advance may be impregnated with an inert gas, or a molten resin composition may be impregnated with an inert gas under pressure and then molded at the time of reducing the pressure. These steps may be carried out in any system of a batch system or a continuous system. Additionally, heating may be carried out after the pressure reduction step or simultaneously with the pressure reduction step.

The inert gas is not particularly limited so far as it is inert to and impregnatable in the foregoing thermoplastic polymer. Examples thereof include carbon dioxide, a nitrogen gas and air. A mixture of such gases may be used. Of these, carbon dioxide whose impregnation amount into the thermoplastic polymer to be used as a material of the foam is large and whose impregnation speed is high is suitable.

The inert gas is preferably in a supercritical state. In the supercritical state, the solubility of the gas in the thermoplastic polymer increases, thereby making it possible to incorporate the inert gas in a high concentration thereinto. Also, since the concentration of the inert gas is high as described previously, at the time of an abrupt pressure drop after the impregnation, the generation of cell nuclei becomes frequent, and even when the porosity is identical, the density of cells formed upon expansion of the cell nuclei becomes large. Thus, fine cells can be obtained. Carbon dioxide has a critical temperature of 31° C. and a critical pressure of 7.4 MPa.

According to the batch system, for example, a foam can be formed in the following manner. That is, first of all, an unfoamed molded article (for example, a foam molding resin sheet, etc.) is formed by extruding a resin composition using an extruder such as a single-screw extruder and a twin-screw extruder. Alternatively, a resin composition is uniformly kneaded using a kneading machine equipped with a roller, a cam, a kneader or a Banbury type blade, and the kneaded mixture is press molded using a hot plate pressing machine, thereby forming an unfoamed molded article containing a thermoplastic polymer as a base resin (for example, a foam molding resin sheet, etc.). Then, the obtained unfoamed molded article is charged in a pressure-resistant container, and a high-pressure inert gas is introduced thereinto, thereby impregnating the unfoamed molded article with the inert gas. In that case, the shape of the unfoamed molded article is not particularly limited, and it may be in any form of a roller form or a plate form or the like. Also, the introduction of the high-pressure inert gas may be performed either continuously or discontinuously. At a point of time when the unfoamed molded article is sufficiently impregnated with the high-pressure inert gas, the pressure is released (in general, up to atmospheric pressure) to form cell nuclei in the base polymer. The cell nuclei may be directly expanded at room temperature, or they may be expanded upon heating according to the necessity. As a heating method, a known and/or customary method using a water bath, an oil bath, a heated roller, a hot-air oven, a far infrared radiation, a near infrared radiation, a microwave or the like can be adopted. After expanding the cells in this way, the cells are rapidly cooled with cold water or the like, whereby the shape is fixed.

On the other hand, according to the continuous system, for example, a foam can be formed in the following manner. That is, a high-pressure inert gas is injected while kneading a resin composition using an extruder such as a single-screw extruder and a twin-screw extruder, and the resin composition is sufficiently impregnated with the gas. Thereafter, the resulting polymer is extruded, the pressure is released (in general, up to atmospheric pressure), and foaming and molding are performed at the same time. Cells are expanded upon heating depending on circumstances. After expanding the cells, the cells are rapidly cooled with cold water or the like, whereby the shape is fixed.

A pressure in the foregoing gas impregnation step is, for example, 6 MPa or more (for example, from about 6 to 100 MPa), and preferably 8 MPa or more (for examples, from about 8 to 100 MPa). In the case where the pressure is lower than 6 MPa, the cell expansion at the time of foaming is remarkable; the cell size becomes excessively large; a small average cell size falling within the foregoing range is not obtainable; and the dust-proof property is lowered. This is because when the pressure is low, the impregnation amount of the gas is relatively small as compared with that at the time of a high pressure, and a cell nucleus formation rate is lowered, whereby the number of formed cell nuclei becomes small; and therefore, the gas amount per cell inversely increases, whereby the cell size becomes extremely large. On the other hand, in a pressure region of lower than 6 MPa, since the cell size and the cell density are largely changed by changing the impregnation pressure only a little, it tends to be difficult to control the cell size and the cell density.

A temperature in the gas impregnation step varies depending upon the type of the used inert gas or thermoplastic polymer or the like and can be chosen over a wide range. In the case of taking into consideration operability or the like, the temperature in the gas impregnation step is, for example, from about 10 to 350° C. For example, in the case where an unfoamed molded article in a sheet form or the like is impregnated with an inert gas, the impregnation temperature is from about 10 to 200° C., and preferably from about 40 to 200° C. in the batch system. Also, in the case where a gas-impregnated molten resin composition is extruded, and foaming and molding are performed at the same time, the impregnation temperature is in general from about 60 to 350° C. in the continuous system. In the case of using carbon dioxide as the inert gas, in order to keep the supercritical state, the temperature at the time of impregnation is preferably 32° C. or higher, and especially preferably 40° C. or higher.

In the foregoing pressure reduction step, a rate of pressure reduction is not particularly limited. In order to obtain a uniform fine cell, the pressure reduction rate is preferably from about 5 to 300 MPa per second. Also, a heating temperature in the foregoing heating step is, for example, from about 40 to 250° C., and preferably from about 60 to 250° C.

The average cell size and the density can be regulated by, for example, properly choosing and setting up operation conditions in the gas impregnation step, for example, a temperature, a pressure, a time, etc.; operation conditions in the pressure reduction step, for example, a pressure reduction rate, a temperature, a pressure, etc.; a heating temperature after the pressure reduction; and the like depending upon the types of the used inert gas and thermoplastic polymer or thermoplastic elastomer, the used additive and the like.

Also, the load against repulsion upon compression to 0.1 mm-thickness and the tensile strength can be regulated by, for example, properly choosing and setting up operation conditions in the gas impregnation step, for example, a temperature, a pressure, a time, etc.; operation conditions in the pressure reduction step, for example, a pressure reduction rate, a temperature, a pressure, etc.; a heating temperature after the pressure reduction; and the like depending upon the types of the used inert gas and thermoplastic polymer or thermoplastic elastomer, the used additive and the like.

As a specific embodiment of the production method which is adopted for the formation of a foam having a thickness of from 0.1 to 1.0 mm, an average cell size of from 10 to 65 μm and a density of from 0.01 to 0.20 g/cm³, for example, there is exemplified an embodiment in which according to the batch system, an unfoamed molded article (for example, a foam molding resin sheet, etc.) is formed; the obtained unfoamed molded article is charged in a pressure-resistant container; a high-pressure inert gas of 6 MPa or more is introduced thereinto at a temperature of from about 10 to 200° C.; the unfoamed molded article is impregnated with the inert gas; and at a point of the time when the unfoamed molded article is sufficiently impregnated with the high-pressure inert gas, the pressure is released up to atmospheric pressure, thereby forming cell nuclei in the unfoamed molded article (base resin). On the other hand, according to the continuous system, there is exemplified an embodiment in which a high-pressure inert gas of 6 MPa or more is injected at a temperature of from about 60 to 350° C. while kneading a resin composition using an extruder such as a single-screw extruder and a twin-screw extruder; the thermoplastic polymer is sufficiently impregnated with the gas; the resulting polymer is then extruded; the pressure is released up to atmospheric pressure; foaming and molding are performed at the same time; cells are expanded; and thereafter, the cells are rapidly cooled with cold water or the like, whereby the shape is fixed.

Impact-Absorbing Material

The impact-absorbing material of the invention is constituted of a foam having the foregoing specified characteristics. Even in a form of a foam alone, the impact-absorbing material can be formed as an impact-absorbing material in which its functions are effectively exhibited. However, the impact-absorbing material may be formed in a form in which a foam is provided with other layer or a substrate (in particular, a pressure-sensitive adhesive layer, etc.) on one surface or both surfaces thereof. For example, when the impact-absorbing material is formed in a form in which a foam is provided with a pressure-sensitive adhesive layer on one surface or both surfaces thereof, a member such as optical members or a part can be fixed or tentatively fixed to an adherend. In consequence, the impact-absorbing material of the invention is preferably one in which a pressure-sensitive adhesive layer is provided on at least one surface (one surface or both surfaces) of a foam constituting the impact-absorbing material.

A pressure-sensitive adhesive which forms the pressure-sensitive adhesive layer is not particularly limited. For example, known pressure-sensitive adhesives such as acrylic pressure-sensitive adhesives, rubber-based pressure-sensitive adhesives (for example, natural rubber-based pressure-sensitive adhesives, synthetic rubber-based pressure-sensitive adhesives, etc.), silicone-based pressure-sensitive adhesives, polyester-based pressure-sensitive adhesives, urethane-based pressure-sensitive adhesives, polyamide-based pressure-sensitive adhesives, epoxy-based pressure-sensitive adhesives, vinyl alkyl ether-based pressure-sensitive adhesives and fluorocarbon-based pressure-sensitive adhesives can be properly chosen and used. Also, the pressure-sensitive adhesive may be a hot-melt pressure-sensitive adhesive. The pressure-sensitive adhesive can be used alone or in combinations of two or more kinds thereof. The pressure-sensitive adhesive may be a pressure-sensitive adhesive in any form, for example, an emulsion-based pressure-sensitive adhesive, a solvent-based pressure-sensitive adhesive, an oligomer-based pressure-sensitive adhesive, a solid-based pressure-sensitive adhesive, etc.

From the viewpoint of preventing the contamination against the adherend or the like, an acrylic pressure-sensitive adhesive is suitable as the pressure-sensitive adhesive.

The pressure-sensitive adhesive layer can be formed by utilizing a known and/or customary method. For example, there are exemplified a method of coating a pressure-sensitive adhesive on a prescribed site or surface (coating method); a method of coating a pressure-sensitive adhesive on a release film such as a release liner to form a pressure-sensitive adhesive layer and then transferring the pressure-sensitive adhesive layer onto a prescribed site or surface (transfer method); and the like. In forming a pressure-sensitive adhesive layer, a known and/or customary coating method (for example, a casting method, a roll coater method, a reverse coater method, a doctor blade method, etc.) can be properly utilized.

A thickness of the pressure-sensitive adhesive layer is in general from about 2 to 100 μm (preferably from 10 to 100 μm). The thinner the thickness of the pressure-sensitive adhesive layer, the higher the effect for preventing the attachment of dirt or dust to an end part is. Therefore, it is preferable that the thickness of the pressure-sensitive adhesive layer is thin. The pressure-sensitive adhesive layer may have any form of a single layer or a laminate.

Also, the pressure-sensitive adhesive layer may be formed on the foam through other layer (lower layer). Examples of such a lower layer include, in addition to a substrate layer (in particular, a film layer) or other pressure-sensitive adhesive layer, an interlayer and an undercoat layer.

Moreover, in the case where the pressure-sensitive adhesive layer is formed on only one of the surfaces (one surface) of the foam, other layer may be formed on the other surface of the foam. Examples thereof include a pressure-sensitive adhesive layer of other type and a substrate layer.

The impact-absorbing material of the invention has an impact-absorbing property, as defined by the following expression (1), of from 40 to 90% (preferably from 45 to 85%).

Impact-absorbing property(%)=(F0−F1)/F0×100 (1)

In the expression (1), F0 represents an impact force at the time of making an impactor collide with only a support plate; and F1 represents an impact force at the time of making an impactor collide with a support plate of a structure composed of a support plate and an impact-absorbing material.

In the impact-absorbing material of the invention, when the impact-absorbing property as defined in the expression (1) is less than 40%, an application as an impact-absorbing material is difficult. On the other hand, when the impact-absorbing property as defined in the expression (1) exceeds 40%, there is a concern that the material becomes too soft to cause a lowering of the strength, whereby workability or processability is lowered.

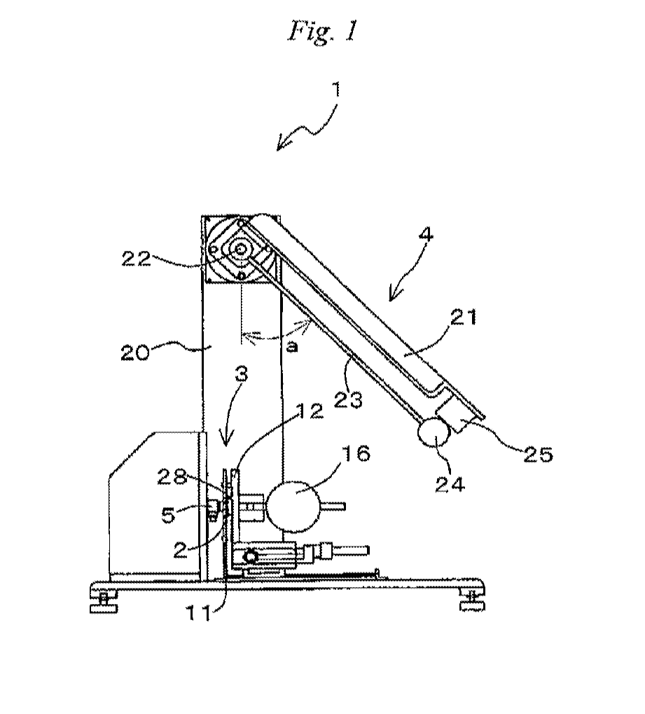

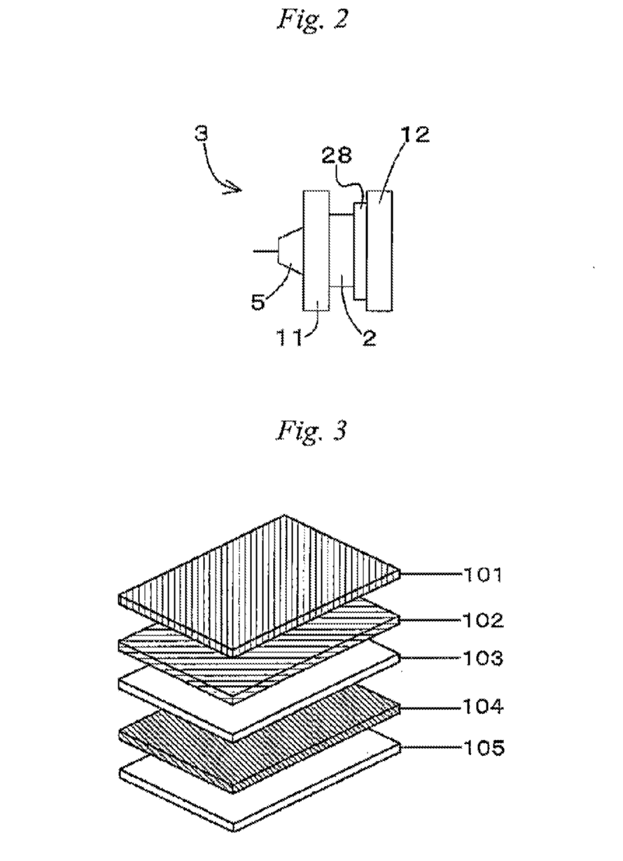

The impact-absorbing property is determined using an impact tester (pendulum type device). A diagrammatic constitution of the impact tester is described with reference to FIGS. 1 and 2. As shown in FIGS. 1 and 2, an impact tester 1 (pendulum type device 1) is constituted of a holding member 3 as a holding unit for holding a specimen 2 (impact-absorbing material 2) with an arbitrary holding power; an impact-loading member 4 for loading an impact stress to the specimen 2; a pressure sensor 5 as an impact force-detecting unit for detecting an impact force acting on the specimen 2 by the impact-loading member 4; and the like. Also, the holding member 3 for holding the specimen 2 with an arbitrary holding power is constituted of a fixing jig 11; and a slidable pressing jig 12 which is disposed opposite to the fixing jig 11 and which is capable of holding the specimen 2 upon interposing it between the both jigs. Furthermore, the pressing jig 12 is provided with a pressing pressure regulator 16. Furthermore, the impact-loading member 4 for loading an impact force to the specimen 2 which is held by the holding member 3 is constituted of a support bar 23 (shaft 23) in which one end 22 thereof is pivoted rotatably relative to a support 20, with an impactor 24 being provided on the side of the other end; and an arm 21 for lifting up the impactor 24 at a prescribed angle to hold it. Here, since a steel ball is used as the impactor 24, by providing an electromagnet 25 on one end of the arm 21, it is possible to integrally lift up the impactor 24 at a prescribed angle. Moreover, the pressure sensor 5 for detecting an impact force acting on the specimen 2 by the impact-loading member 4 is provided on the side of the opposite surface to the surface of the fixing jig 11 with which the specimen 2 comes into contact.

In the invention, the impactor 24 is a steel ball. Also, the angle at which the impactor 24 is lifted up by the arm 21 (a swing angle a in FIG. 1) is about 40°.

As shown in FIG. 2, the specimen 2 (impact-absorbing material 2) is interposed between the fixing jig 11 and the pressing jig 12 through a support plate 28 which is constituted of a plate material with high elasticity such as resin-made plate materials and metal-made plate materials.

The impact-absorbing property is calculated according to the following expression (1) after determining an impact force F0 which is measured by fixing the fixing jig 11 and the support plate 28 closely to each other and then making the impactor 24 collide with the support plate 28 and an impact force F1 which is measured by inserting the specimen 2 between the fixing jig 11 and the support plate 28, fixing the fixing jig 11 and the support plate 28 closely to each other and then making the impactor 24 collide with the support plate 28.

Impact-absorbing property(%)=(F0−F1)/F0×100 (1)

The impact tester is the same device as that in Example 1 of JP-A-2006-47277.

The impact-absorbing property can be regulated by choosing the thickness, average cell size and density and the like of the foregoing foam constituting the impact-absorbing material.

Also, it is preferable that the impact-absorbing material of the invention has an impact-absorbing characteristic such that, in a falling ball test in which a laminate obtained by laminating a polarizing plate, an LCD panel, a double-coated pressure-sensitive adhesive tape, the impact-absorbing material and a double-coated pressure-sensitive adhesive tape in this order, with the polarizing plate being an upper surface, is used as a module, and after locating an acrylic plate on the upper surface of the module, an operation of freely falling a 0.39 N-steel ball on the acrylic plate from a height of 150 cm is repeated until the LCD panel is broken, the number of repetition measured at the time when the breakage is first generated on the LCD panel is 80 times or more.

When such an impact-absorbing characteristic is provided, in particular, at the time of installing or processing the impact-absorbing material in an LCD panel, an organic EL panel or the like, even if the thickness is thin, excellent workability such that no breakage is generated is revealed.

The falling ball test is carried out by repeating an operation of freely falling an impactor made of a steel ball of 0.39 N (40 gf) on a sample prepared by locating an acrylic plate on the an upper surface of the following module from a height of 150 cm until fracture or breakage or the like is generated on an LCD panel in the module and measuring the number of repetition at the time when the fracture or breakage or the like is first generated on the LCD panel. An upper limit of the number of repetition is defined to be 200 times. As the acrylic plate, for example, one having a thickness of 1.0 mm is used. Also, the acrylic plate is located on the upper surface of the module and is not fixed to the module. At the time of performing the falling ball test, the module is fixed to a pedestal.

The module which is used in the falling ball test is shown in FIG. 3. In FIG. 3, 101 stands for a polarizing plate; 102 stands for an LCD panel; 103 stands for a double-coated pressure sensitive adhesive tape (in this application, the term “tape” is an abbreviation of “tape or sheet” and includes a concept of both a tape and a sheet); 104 stands for an impact-absorbing material (foam); and 105 stands for a double-coated pressure sensitive adhesive tape. In the module, the surface of the side of the polarizing plate 101 is an upper surface. Examples of the polarizing plate 101 include a polarizing plate made of triacetyl cellulose as a material and having a thickness of 0.25 mm. Examples of the LCD panel 102 include an LCD panel made of a glass as a material and having a total thickness of 0.5 mm. In the module, as the double-coated pressure sensitive adhesive tape 103 and the double-coated pressure sensitive adhesive tape 105, those which do not affect the impact-absorbing characteristic in the falling ball test are chosen. In this way, the module has a constitution in which the polarizing plate 101, the LCD panel 102, the double-coated tape pressure sensitive adhesive 103, the impact-absorbing material 104 and the double-coated pressure sensitive adhesive tape 105 are laminated in this order from the upper surface toward the lower surface.

The impact-absorbing characteristic by the falling ball test can be regulated by choosing the thickness, average cell size and density and the like of the foregoing foam constituting the impact-absorbing material.

Furthermore, it is preferable that the impact-absorbing material of the invention has a load against repulsion upon compression to 0.1 mm-thickness (a repulsive stress upon compression to 0.1 mm-thickness) of from 0.005 to 0.100 MPa. By regulating an upper limit of the load against repulsion upon compression to 0.1 mm-thickness to 0.100 MPa or less (preferably 0.070 MPa or less, and more preferably 0.040 MPa or less), even in a narrow clearance, it is possible to prevent the generation of a fault to be caused due to repulsion of the impact-absorbing material. On the other hand, by regulating a lower limit of the load against repulsion upon compression to 0.1 mm-thickness to 0.005 MPa or more (preferably 0.008 MPa or more, and more preferably 0.010 MPa or more), it is possible to secure an excellent dust-proof property in addition to the impact-absorbing property.

Furthermore, it is preferable that the impact-absorbing material of the invention has a tensile strength of from 3.0 to 11.0 MPa. By regulating an upper limit of the tensile strength to 11.0 MPa or less (preferably 10.5 MPa or less, and more preferably 10.0 MPa or less), in the impact-absorbing material, an impact-absorbing property is more easily obtainable without impairing flexibility. On the other hand, by regulating a lower limit of the tensile strength to 3.0 MPa or more (preferably 3.5 MPa or more, and more preferably 3.8 MPa or more), the installation or processing is more easily achieved without impairing the workability.

The load against repulsion upon compression to 0.1 mm-thickness or tensile strength of the impact-absorbing material can be regulated by choosing the thickness, average cell size and density and the like of the foregoing foam constituting the impact-absorbing material.

The shape and thickness and the like of the impact-absorbing material of the invention are not particularly limited and can be properly chosen depending upon applications or the like. From the viewpoint of the fact that excellent flexibility capable of following even a finer clearance as from 0.10 to 0.20 mm is obtainable, for example, it is preferable to choose the thickness of the impact-absorbing material within the range of from about 0.10 to 0.5 mm (preferably from 0.15 to 0.3 mm).

Also, in general, the impact-absorbing material is processed into a variety of shapes in conformity with a device to be used and formed as a product.

Since the impact-absorbing material of the invention includes the foregoing foam, it has a very fine cell structure and is favorable in the flexibility and low in the density. Furthermore, the impact-absorbing material of the invention is low in the load against repulsion upon compression to 0.1 mm-thickness (a repulsive stress upon compression to 0.1 mm-thickness). That is, the impact-absorbing material of the invention reveals excellent flexibility so as to cope with a fine clearance while keeping the cell size small, and therefore, it is able to well follow a finer clearance while keeping originally needed dust-proof capability and impact-absorbing capability. Furthermore, the impact-absorbing material of the invention has high expansion and lightweight. Moreover, since the impact-absorbing material of the invention has a fine cell structure, it has also shape processability.

Also, the foam is excellent in the flexibility because it is composed of a thermoplastic polymer such as a thermoplastic elastomer. Also, unlike conventional impact-absorbing materials prepared by a physical foaming method or a chemical foaming method, the impact-absorbing material of the invention is clean without causing the generation of a noxious substance or retention of a pollutant because an inert gas such as carbon dioxide is used as the foaming agent. For those reasons, in particular, the impact-absorbing material of the invention can also be suitably utilized as an impact-absorbing material which is used in the inside of an electronic equipment or the like.

In consequence, the impact-absorbing material of the invention is useful as an impact-absorbing material which is used at the time of setting (installing) a variety of members or parts (for example, optical members, etc.) in a prescribed site. In particular, since the impact-absorbing material of the invention is able to fill a fine clearance between highly densified parts, it can be suitably used even at the time of installing a small-sized member or part (for example, a small-sized optical member, etc.) in a thin-type product.

Examples of the optical member with which the impact-absorbing material of the invention can be set (installed) include image display members to be installed in an image display device such as a liquid crystal display, an electroluminescence display and a plasma display; and cameras or lenses (especially small-sized cameras or lenses) to be installed in a mobile communication device such as a so-called “cellular phone” or “personal digital assistant”.

Also, the impact-absorbing material of the invention can be used as a cushioning material at the time of preventing leakage of a toner from a toner cartridge.

Furthermore, the impact-absorbing material of the invention can also be used as a cushioning material of an electroluminescence panel of an electroluminescence display.

Structure Having an Optical Member

In a structure having an optical member (a structure in which an optical member is set in a prescribed site), the optical member is set (installed) in a prescribed site through the foregoing impact-absorbing material. Examples of such a structure include image display devices such as a liquid crystal display, an electroluminescence display and a plasma display (in particular, image display devices installed with a small-sized image display member as the optical member); and mobile communication devices installed with a camera or a lens (in particular, a small-sized camera or lens) as the optical member, such as a so-called “cellular phone” or “personal digital assistant”. The structure may be a conventional thin-type product, and its thickness or shape or the like is not particularly limited.

Impact-Absorbing Structure

An impact-absorbing structure (an impact-absorbing structure in setting an optical member in a prescribed site) has a structure in which an optical member is set through the foregoing impact-absorbing material. The impact-absorbing structure is not particularly limited with respect to other structure so far as the foregoing impact-absorbing material is used in setting (installing) the optical member in a prescribed site. In consequence, the optical member and the prescribed site in which the optical member is set and the like are not particularly limited, and they can be properly chosen. Examples of such an optical member include the foregoing optical members.

### EXAMPLES

The invention is hereunder described in more detail with reference to the following Examples, but it should not be construed that the invention is limited to these Examples. Incidentally, an average cell size and a density were determined by the following methods.

Average Cell Size

An average cell size (μm) was determined by taking an enlarged image of a cell part of a foam by a digital microscope (a trade name; VHX-500, manufactured by Keyence Corporation) and image analyzing it using an image analysis software (a trade name: Win PROOF, manufactured by Mitani Corporation). The number of cells in the taken enlarged image is about 100.

Density

A foam is punched out by a punching blade of 100 mm×100 mm, and a size of the punched sample is measured. Also, its thickness is measured by a 1/100 dial gauge having a diameter (φ)) of a measuring terminal of 20 mm. A volume of the foam was calculated from these values.

Next, a weight of the foam was measured by an even balance having a minimum scale of 0.01 g of more. A density (g/cm³) of the foam was calculated from these values.

### Example 1

45 parts by weight of polypropylene [melt flow rate (MFR) (at 230° C.): 0.35 g/10 min], 55 parts by weight of a polyolefin-based elastomer [melt flow rate (MFR): 6 g/10 min, JIS A hardness: 79°], 10 parts by weight of magnesium hydroxide, 10 parts by weight of carbon (a trade name: ASAHI #35, manufactured by Asahi Carbon Co., Ltd.), 1 part by weight of stearic acid monoglyceride and 2 parts by weight of an aliphatic acid amide (lauric acid bisamide) were kneaded at a temperature of 200° C. by a twin-screw kneading machine, manufactured by Japan Steel Works Ltd. (JSW). Thereafter, the kneaded mixture was extruded in a strand form, cooled with water and then molded in a pellet form. This pellet was charged in a single-screw extruder, manufactured by Japan Steel Works Ltd., and a carbon dioxide gas was injected in an environment at 220° C. under a pressure of 13 MPa (12 MPa alter the injection). The carbon dioxide gas was injected in a proportion of 6 parts by weight based on 100 parts by weight of the polymer. After sufficiently saturating the carbon dioxide gas, the pellet was cooled to a temperature suitable for foaming and then extruded from a die to obtain a foam. This foam had an average cell size of 50 μm and a density of 0.05 g/cm³. A thickness of the foam was regulated to 0.15 mm.

### Example 2

45 parts by weight of polypropylene [melt flow rate (MFR) (at 230° C.): 0.35 g/10 min], 55 parts by weight of a polyolefin-based elastomer [melt flow rate (MFR): 6 g/10 min, JIS A hardness: 79°], 120 parts by weight of magnesium hydroxide, 10 parts by weight of carbon (a trade name: ASAHI #35, manufactured by Asahi Carbon Co., Ltd.) and 1 part by weight of stearic acid monoglyceride were kneaded at a temperature of 200° C. by a twin-screw kneading machine, manufactured by Japan Steel Works Ltd. (JSW). Thereafter, the kneaded mixture was extruded in a strand form, cooled with water and then molded in a pellet form. This pellet was charged in a single-screw extruder, manufactured by Japan Steel Works Ltd., and a carbon dioxide gas was injected in an environment at 220° C. under a pressure of 13 MPa (12 MPa after the injection). The carbon dioxide gas was injected in a proportion of 6 parts by weight based on 100 parts by weight of the polymer. After sufficiently saturating the carbon dioxide gas, the pellet was cooled to a temperature suitable for foaming and then extruded from a die to obtain a foam. This foam had an average cell size of 60 μm and a density of 0.12 g/cm³. A thickness of the foam was regulated to 0.15 mm.

### Example 3

45 parts by weight of polypropylene [melt flow rate (MFR) (at 230° C.): 0.35 g/10 min], 55 parts by weight of a polyolefin-based elastomer [melt flow rate (MFR): 6 g/10 min, JIS A hardness: 79°], 10 parts by weight of magnesium hydroxide, 10 parts by weight of carbon (a trade name: ASAHI #35, manufactured by Asahi Carbon Co., Ltd.), 1 part by weight of stearic acid monoglyceride and 2 parts by weight of a aliphatic acid amide (lauric acid bisamide) were kneaded at a temperature of 200° C. by a twin-screw kneading machine, manufactured by Japan Steel Works Ltd. (JSW). Thereafter, the kneaded mixture was extruded in a strand form, cooled with water and then molded in a pellet form. This pellet was charged in a single-screw extruder, manufactured by Japan Steel Works Ltd., and a carbon dioxide gas was injected in an environment at 220° C. under a pressure of 13 MPa (12 MPa after the injection). The carbon dioxide gas was injected in a proportion of 6 parts by weight based on 100 parts by weight of the polymer. After sufficiently saturating the carbon dioxide gas, the pellet was cooled to a temperature suitable for foaming and then extruded from a die to obtain a foam. This foam had an average cell size of 50 μm and a density of 0.05 g/cm³. A thickness of the foam was regulated to 0.20 mm.

### Example 4

45 parts by weight of polypropylene [melt flow rate (MFR) (at 230° C.): 0.35 g/10 min], 55 parts by weight of a polyolefin-based elastomer [melt flow rate (MFR): 6 g/10 min, JIS A hardness: 79°], 10 parts by weight of magnesium hydroxide, 120 parts by weight of carbon (a trade name: ASAHI ∩35, manufactured by Asahi Carbon Co., Ltd.) and 1 part by weight of stearic acid monoglyceride were kneaded at a temperature of 200° C. by a twin-screw kneading machine, manufactured by Japan Steel Works Ltd. (JSW). Thereafter, the kneaded mixture was extruded in a strand form, cooled with water and then molded in a pellet form. This pellet was charged in a single-screw extruder, manufactured by Japan Steel Works Ltd., and a carbon dioxide gas was injected in an environment at 220° C. under a pressure of 13 MPa (12 MPa after the injection). The carbon dioxide gas was injected in a proportion of 6 parts by weight based on 100 parts by weight of the polymer. After sufficiently saturating the carbon dioxide gas, the pellet was cooled to a temperature suitable for foaming and then extruded from a die to obtain a foam. This foam had an average cell size of 60 μm and a density of 0.12 g/cm³. A thickness of the foam was regulated to 0.20 mm.

### Example 5

45 parts by weight of polypropylene (melt flow rate (MFR) (at 230° C.): 0.35 g/10 min), 55 parts by weight of a polyolefin-based elastomer [melt flow rate (MFR): 6 g/10 min, JIS A hardness: 79°], 10 parts by weight of magnesium hydroxide, 10 parts by weight of carbon (a trade name: ASAHI #35, manufactured by Asahi Carbon Co., Ltd.), 1 part by weight of stearic acid monoglyceride and 2 parts by weight of a aliphatic acid amide (lauric acid bisamide) were kneaded at a temperature of 200° C. by a twin-screw kneading machine, manufactured by Japan Steel Works Ltd. (JSW). Thereafter, the kneaded mixture was extruded in a strand form, cooled with water and then molded in a pellet form. This pellet was charged in a single-screw extruder, manufactured by Japan Steel Works Ltd., and a carbon dioxide gas was injected in an environment at 220° C. under a pressure of 13 MPa (12 MPa after the injection). The carbon dioxide gas was injected in a proportion of 6 parts by weight based on 100 parts by weight of the polymer. After sufficiently saturating the carbon dioxide gas, the pellet was cooled to a temperature suitable for foaming and then extruded from a die to obtain a foam. This foam had an average cell size of 50 μm and a density of 0.05 g/cm³, A thickness of the foam was regulated to 0.30 mm.

### Comparative Example 1

A foam composed mainly of polyurethane and having characteristics of an average cell size of 45 μm, a thickness of 0.15 mm and a density of 0.95 g/cm³ was used.

### Comparative Example 2

A foam composed mainly of polyurethane and having characteristics of an average cell size of 45 μm, a thickness of 0.15 mm and a density of 0.90 g/cm³ was used.

### Comparative Example 3

A foam composed mainly of polyurethane and having characteristics of an average cell size of 50 μm, a thickness of 0.20 mm and a density of 0.80 g/cm³ was used.

### Comparative Example 4

A foam composed mainly of polypropylene and having characteristics of an average cell size of 60 μm, a thickness of 0.20 mm and a density of 0.40 g/cm³ was used.

### Comparative Example 5

A foam composed mainly of polyethylene and having characteristics of an average cell size of 50 μm, a thickness of 0.20 mm and a density of 0.23 g/cm³ was used.

Evaluation

The foams of Examples and Comparative Examples were measured with respect to an impact-absorbing property, a load against repulsion upon compression to 0.1 mm-thickness (a repulsive stress upon compression to 0.1 mm-thickness) and a tensile strength. Also, an impact-absorbing characteristic was evaluated by performing a falling ball test. The obtained results are shown in Table 1.

Impact-Absorbing Property

Using the impact tester (pendulum type device) as shown in FIGS. 1 and 2, an impact force (F0) at the time of making a steel ball collide with only a support plate and an impact force (F1) at the time of making a steel ball collide with a support plate in a state of inserting a foam (foamed material) between a fixing jig and a support plate were measured, and an impact-absorbing property was determined according to the following expression (1).

Impact-absorbing property(%)=(F0−F1)/F0×100 (1)

As the foam, one having a size of 20 mm in square was used. Also, in the impact tester, a steel ball having a diameter of 19 mm and a weight of 0.27 N (28 gf) is attached by a support bar having a length of 350 mm. In the impact tester, an aluminum plate was used as the fixing jig.

As the support plate, an acrylic plate (a trade name: ACRYLITE, manufactured by Mitsubishi Rayon Co., Ltd., thickness: 3 mm) was used.

At the time of measuring an impact force, an adhesive for fixing a specimen to the support plate was used within the range where the measurement of an impact force was not affected.

The impact force was determined by MULTI-Purpose FTT Analyzer (manufactured by Ono Sokki Co., Ltd.) by swinging up the support bar having a steel ball attached thereto at an angle of 40° and fixing it; releasing the fixing, making the steel ball collide with the support plate; and detecting a force at the time of the collision by a pressure sensor.

Load Against Repulsion Upon Compression to 0.1 mm-Thickness

A load against repulsion upon compression to 0.1 mm-thickness was measured according to the compression hardness measurement method described in JIS K6767. Specifically, a stress (N) at the time of compressing a specimen cut into a circular form having a diameter of 20 mm to a thickness of 0.1 mm at a compression rate of 2.54 mm/min was converted into one per a unit area (1 cm²), thereby defining the converted value as a load against repulsion upon compression to 0.1 mm-thickness (a repulsive stress upon compression to 0.1 mm-thickness) (MPa).

Tensile Strength

A tensile strength (MPa) of the foam was measured on the basis of the tensile strength item of JIS K6767.

Falling Ball Test

As a module (specimen), a laminate obtained by laminating a polarizing plate (material: triacetyl cellulose, thickness: 0.25 mm), an LCD panel (material: glass, total thickness: 0.5 mm), a double-coated pressure sensitive adhesive tape (a trade name: No. 5603, manufactured by Nitto Denko Corporation), a foam and a double coated pressure sensitive adhesive tape (a trade name: No. 5603) in this order, with the polarizing plate being an upper surface (see FIG. 3) was used. An acrylic plate (a trade name: ACRYLITE, manufactured by Mitsubishi Rayon Co., Ltd., thickness: 1 mm) was set on the upper surface of this module. The acrylic plate was used in a free state without being fixed. Also, a marble-made pedestal was used as a pedestal, and the module was fixed onto the pedestal.

The test was carried out by repeating an operation of freely falling an impactor made of a steel ball of 0.39 N (40 gf) on the foregoing module having an acrylic plate set on the upper surface thereof from a height of 150 cm until fracture was generated on the LCD panel and measuring the number of repetition at the time when the LCD panel was fractured. An upper limit of the number of repetition of the free falling against the module of the impactor was defined to be 200 times.

In Table 1, it is meant by the term “>200” that even when the free falling against the module of the impactor was carried out 200 times, fracture or breakage of the LCD panel was not generated.

TABLE 1

| | Example | | | | |
|---|---|---|---|---|---|
| | 1 | 2 | 3 | 4 | 5 |
| Thickness (mm) | 0.15 | 0.15 | 0.20 | 0.20 | 0.30 |
| Average cell size (μm) | 50 | 60 | 50 | 60 | 50 |
| Density (g/cm³) | 0.05 | 0.12 | 0.05 | 0.12 | 0.05 |
| Tensile strength (MPa) | 9.5 | 9.3 | 6.9 | 6.7 | 3.9 |
| Repulsive stress upon | 0.01 | 0.01 | 0.02 | 0.02 | 0.02 |
| compression to 0.1 mm- | | | | | |
| thickness (MPa) | | | | | |
| Impact-absorbing | 51 | 48 | 60 | 57 | 68 |
| property (%) | | | | | |
| Falling ball test (times) | >200 | >200 | >200 | >200 | >200 |
| | Comparative Example | | | | |
| | 1 | 2 | 3 | 4 | 5 |
| Thickness (mm) | 0.15 | 0.15 | 0.20 | 0.20 | 0.20 |
| Average cell size (μm) | 45 | 45 | 50 | 60 | 50 |
| Density (g/cm³) | 0.95 | 0.90 | 0.80 | 0.40 | 0.23 |
| Tensile strength (MPa) | 24.2 | 10.8 | 43.9 | 12.1 | 12.5 |
| Repulsive stress upon | 0.05 | 0.05 | 0.13 | 0.47 | 0.15 |
| compression to 0.1 mm- | | | | | |
| thickness (MPa) | | | | | |
| Impact-absorbing | 21 | 9 | 33 | 36 | 35 |
| property (%) | | | | | |
| Falling ball test (times) | 10 | 3 | 47 | 49 | 68 |

As is clear from Table 1, Examples show an excellent impact-absorbing property because they have a small density and have flexibility. Also, this effect is reflected on the number of repetition until the LCD panel is fractured in the falling ball test. This is also evident from the fact that the panel fracture is suppressed in comparison with the Comparative Examples.

While the invention has been described in detail and with reference to specific embodiments thereof, it will be apparent to one skilled in the art that various changes and modifications can be made therein without departing from the spirit and scope thereof.

This application is based on Japanese Patent Application No. 2009-065004 filed on Mar. 17, 2009, the entirety of which is incorporated herein by way of reference.

According to the impact-absorbing material of the invention, since it has the foregoing constitution, even when the thickness is thin, it is able to have excellent flexibility and an excellent impact-absorbing property and to follow a fine clearance.

What is claimed is:

1. An impact-absorbing material comprising a foam having a thickness of from 0.1 to 1.0 mm, an average cell size of from 10 to 65 μm and a density of from 0.01 to 0.20 g/cm³ and having an impact-absorbing property, as defined in the following expression (1), of from 40 to 90%:
Impact-absorbing property(%)=(F0−F1)/F0×100 (1)
wherein F0 represents an impact force at the time of making an impactor collide with only a support plate; and F1 represents an impact force at the time of making an impactor collide with a support plate of a structure composed of the support plate and the impact-absorbing material.

2. The impact-absorbing material according to claim 1, having an impact-absorbing characteristic such that, in a falling ball test in which a laminate obtained by laminating a polarizing plate, an LCD panel, a double-coated pressure-sensitive adhesive tape, the impact-absorbing material and a double-coated pressure-sensitive adhesive tape in this order, with the polarizing plate being an upper surface, is used as a module, and after locating an acrylic plate on the upper surface of the module, an operation of freely falling a 0.39 N-steel ball on the acrylic plate from a height of 150 cm is repeated until the LCD panel is broken, the number of repetition measured at the time when the breakage is first generated on the LCD panel is 80 times or more.

3. The impact-absorbing material according to claim 1, having a load against repulsion upon compression to 0.1 mm-thickness of from 0.005 to 0.100 MPa.

4. The impact-absorbing material according to claim 1, having a tensile strength of from 3.0 to 11.0 MPa.

5. The impact-absorbing material according to claim 1, wherein the foam is formed through steps of impregnating a resin composition with a high-pressure inert gas and then reducing the pressure.

6. The impact-absorbing material according to claim 1, wherein the foam is formed through steps of impregnating an unfoamed molded article comprising a resin composition with a high-pressure inert gas and then reducing the pressure.

7. The impact-absorbing material according to claim 1, wherein the foam is formed through steps of impregnating a molten resin composition with an inert gas under pressure and then reducing the pressure and simultaneously molding.

8. The impact-absorbing material according to claim 5, wherein heating is carried out after the pressure reduction or simultaneously with the pressure reduction.

9. The impact-absorbing material according to claim 6, wherein heating is carried out after the pressure reduction or simultaneously with the pressure reduction.

10. The impact-absorbing material according to claim 7, wherein heating is carried out after the pressure reduction or simultaneously with the pressure reduction.

11. The impact-absorbing material according to claims 5, wherein the inert gas is carbon dioxide.

12. The impact-absorbing material according to claims 6, wherein the inert gas is carbon dioxide.

13. The impact-absorbing material according to claims 7, wherein the inert gas is carbon dioxide.

14. The impact-absorbing material according to claim 5, wherein the inert gas is in a supercritical state.

15. The impact-absorbing material according to claim 6, wherein the inert gas is in a supercritical state.

16. The impact-absorbing material according to claim 7, wherein the inert gas is in a supercritical state.

17. The impact-absorbing material according to claim 1, wherein a pressure-sensitive adhesive layer is provided on one surface or both surfaces of the foam.

18. The impact-absorbing material according to claim 17, wherein the pressure-sensitive adhesive layer is formed on the foam through a film layer.

19. The impact-absorbing material according to claim 17, wherein the pressure-sensitive adhesive layer is formed of an acrylic pressure-sensitive adhesive.
